(19) United States
(12) Patent Application Publication
(10) Pub. No.: US 2023/0002975 A1
(43) Pub. Date: Jan. 5, 2023

(54) POWDERY PAPER-STRENGTHENING AGENT, PAPER-STRENGTHENING AGENT SOLUTION, AND PAPER

(71) Applicant: ARAKAWA CHEMICAL INDUSTRIES, LTD., Osaka (CN)

(72) Inventors: Keisuke Okada, Osaka (JP); Hiroyuki Ioka, Osaka (JP); Daisuke Fujioka, Ibaraki (JP)

(21) Appl. No.: 17/630,099

(22) PCT Filed: Jul. 10, 2020
(86) PCT No.: PCT/JP2020/027124

§ 371 Date: Jan. 25, 2022

(30) Foreign Application Priority Data
Aug. 2, 2019 (JP) 2019-142667

(51) Int. Cl. D21H 21/18; C08F 220/56; D21H 17/45

(52) U.S. Cl. CPC D21H 21/18; C08F 220/56; D21H 17/455; C08F 2800/10

(57) ABSTRACT

Provided is a powdery paper-strengthening agent comprising an amphoteric (meth)acrylamide-based polymer (A) having a weight-average molecular weight of 1,000,000 to 7,000,000, wherein the amphoteric (meth)acrylamide-based polymer (A) comprises, as constituent monomers, (meth)acrylamide which is an (a1) component, a cationic unsaturated monomer which is an (a2) component, an anionic unsaturated monomer which is an (a3) component, and a crosslinkable unsaturated monomer which is an (a4) component, and wherein an aqueous solution, in which the amphoteric (meth)acrylamide-based polymer (A) is dissolved in a calcium chloride aqueous solution having an electrical conductivity of 4 mS/cm at 25° C. so as to be 1% by weight, has a maximum turbidity of 10 to 2500 NTU at pH 3 to 9.

### CROSS-REFERENCE TO RELATED APPLICATIONS

This application is the U.S. National Stage of PCT/JP2020/027124 filed Jul. 10, 2020, which claims priority to Japanese Patent Application No. 2019142667 filed Aug. 2, 2019, the content of both are incorporated herein by reference in their entirety.

### TECHNICAL FIELD

The present invention relates to a powdery paper-strengthening agent, a paper-strengthening agent solution, and paper.

### BACKGROUND ART

Paper has been utilized as a recyclable resource for various applications. In the paper industry, as part of environmental measures, recycling of a used paper and reduction of a water consumption (closed system) have been tackled. However, if a used paper is continuously recycled, fibrils on a pulp surface will decrease, and interfiber bonds in paper will decrease. Furthermore, strength of a pulp fiber itself will be also reduced, and therefore strength of the obtained paper will be reduced. As a result, a paper-strengthening agent becomes indispensable one for compensating for decrease in strength during papermaking.

In addition, as recycling of a used paper and closed system develop, fine fibers and dissolved electrolyte substances are accumulated in a papermaking system. Therefore, an electrical conductivity of the papermaking system tends to increase. Among dissolved electrolyte substances, calcium ions are particularly abundant. Calcium ions are not only originally contained in a papermaking white water, but also generated from calcium carbonate added to a pulp slurry, enhancing the electrical conductivity of the papermaking system. The electrical conductivity is increasing even when it exceeds 4 mS/cm. Under such circumstances, an amphoteric paper-strengthening agent is difficult to exhibit an original paper-strengthening effect because an ion portion is shielded by a dissolved electrolyte such as a calcium ion. A (meth)acrylamide-based polymer is used as a paper-strengthening agent for one of such papermaking additives.

The (meth)acrylamide-based polymer can be classified into an anionic type, a cationic type, or an amphoteric type according to ionicity thereof. Currently, the amphoteric type is mainly used. The amphoteric type (meth)acrylamide-based polymer is obtained by copolymerizing acrylamide with various polymerization components such as a cationic monomer and an anionic monomer. The (meth)acrylamide-based polymer has an isoelectric point and forms a polyion complex (hereinafter, referred to as “PIC”) at a pH near the isoelectric point. The isoelectric point refers to a pH at which an electric charge of a polymer as a whole becomes 0 when the pH is changed, and PIC refers to a water-insoluble substance formed by bonding polymers having anionic or cationic groups by ionic bond. When PIC is formed, a phenomenon of cloudiness is observed, and further, a non-uniform state may be created or an insoluble substance may be generated. By forming PIC, the (meth)acrylamide-based polymer is known to exhibit high filterability, yield, and paper-strengthening effect.

In addition, as a paper-strengthening agent comprising the above-described polymers, one having a branched structure and a high molecular weight in order to exhibit an excellent paper-strengthening effect when made into paper has been mainly used, and one of an aqueous solution type has been generally used. However, the aqueous solution type paper-strengthening agent has a problem that a cationic component is hydrolyzed during a long-term storage and therefore a sufficient paper-strengthening effect cannot be obtained, and as a countermeasure, a powder type paper-strengthening agent has been developed.

A powder type (meth)acrylamide-based polymer is known to be obtained by polymerization with heat or ultraviolet irradiation (the former is referred to as a “boiling polymerization method” and the latter as an “ultraviolet polymerization method”) (Patent Documents 1 and 2).

### PRIOR ART DOCUMENT

### Patent Document

Patent Document 1: WO2011/122405
Patent Document 2: WO2013/031245

### SUMMARY OF THE INVENTION

However, in the methods described in Patent Documents 1 and 2, it is difficult to control reaction when trying to introduce a branched structure. Therefore, the obtained (meth)acrylamide-based polymer has a low weight-average molecular weight and is difficult to exhibit a sufficient paper-strengthening effect.

It is an object of the present invention to provide a powdery paper-strengthening agent, a paper-strengthening agent solution, and paper which have a high molecular weight, an excellent storage stability, and also an excellent paper-strengthening effect when added to a pulp slurry having a high electrical conductivity.

The present inventors have considered that a reason why a paper-strengthening effect is not exhibited when papermaking is performed using water having a high electrical conductivity is that a (meth)acrylamide-based polymer is difficult to form PIC due to shielding of an ionic charge in a papermaking system, and conducted intensive studies. Then, they have found that a powdery paper-strengthening agent comprising a (meth)acrylamide-based polymer obtained by combining monomer components can solve the above-described problems, and completed the present invention.

The powdery paper-strengthening agent of the present invention that solves the above-described problems comprises an amphoteric (meth)acrylamide-based polymer (A) having a weight-average molecular weight of 1,000,000 to 7,000,000, wherein the amphoteric (meth)acrylamide-based polymer (A) comprises, as constituent monomers, (meth)acrylamide which is an (a1) component, a cationic unsaturated monomer which is an (a2) component, an anionic unsaturated monomer which is an (a3) component, and a crosslinkable unsaturated monomer which is an (a4) component, and wherein an aqueous solution, in which the amphoteric (meth)acrylamide-based polymer (A) is dissolved in a calcium chloride aqueous solution having an electrical conductivity of 4 mS/cm at 25° C. so as to be 1% by weight, has a maximum turbidity of 10 to 2500 NTU at pH 3 to 9.

The paper-strengthening agent solution of the present invention that solves the above-described problems is a paper-strengthening agent solution comprising the above-described powdery paper-strengthening agent and water.

The paper of the present invention that solves the above-described problems is paper obtained by using the above-described paper-strengthening agent solution.

### BRIEF DESCRIPTION OF THE DRAWINGS

FIG. 1 is a drawing having “one peak” of a distribution of turbidity.

FIG. 2 is a drawing having “two peaks” of a distribution of turbidity.

### EMBODIMENT FOR CARRYING OUT THE INVENTION

The powdery paper-strengthening agent according to one embodiment of the present invention comprises an amphoteric (meth)acrylamide-based polymer (A) (hereinafter, also referred to as an (A) component) having a weight-average molecular weight of 1,000,000 to 7,000,000. The amphoteric (meth)acrylamide-based polymer (A) comprises, as constituent monomers, (meth)acrylamide which is an (a1) component, a cationic unsaturated monomer which is an (a2) component, an anionic unsaturated monomer which is an (a3) component, and a crosslinkable unsaturated monomer which is an (a4) component. In the powdery paper-strengthening agent, an aqueous solution, in which the amphoteric (meth)acrylamide-based polymer (A) is dissolved in a calcium chloride aqueous solution having an electrical conductivity of 4 mS/cm at 25° C. so as to be 1% by weight, has a maximum turbidity of 10 to 2500 NTU at pH 3 to 9. Besides, (meth)acryl means methacryl or acryl (the same applies hereinafter). Moreover, “unsaturated monomer” means one having one or more double bonds or triple bonds in one molecule of a monomer.

The (a1) component means methacrylamide or acrylamide. They may be used in combination.

A content of the (a1) component is not particularly limited. The content of the (a1) component is preferably 70 mol % or more, more preferably 75 mol % or more, further preferably 85 mol % or more, in all constituent monomers, from the viewpoint of securing a sufficient paper-strengthening effect of paper. The content of the (a1) component is preferably 98 mol % or less, more preferably 95 mol % or less, in all constituent monomers. When the content of the (a1) component is within the above-described ranges, the obtained paper tends to exhibit a sufficient paper-strengthening effect.

The (a2) component is not particularly limited as long as it has cationic properties. By way of an example, the (a2) component is an unsaturated monomer having a secondary amino group, an unsaturated monomer having a tertiary amino group, or quaternized salts of these unsaturated monomers.

The unsaturated monomer having a secondary amino group is not particularly limited. By way of an example, the unsaturated monomer having a secondary amino group is diallylamine or the like. The unsaturated monomer having a tertiary amino group is not particularly limited. By way of an example, the unsaturated monomer having a tertiary amino group is (meth)acrylate having a tertiary amino group such as N,N-dimethylaminoethyl (meth)acrylate and N,N-diethylaminoethyl (meth)acrylate; (meth)acrylamide having a tertiary amino group such as N,N-dimethylaminopropyl (meth)acrylamide and N,N-diethylaminopropyl (meth)acrylamide, or the like. The quaternized salts of these monomers mean those obtained by reacting the unsaturated monomer having a secondary amino group or the unsaturated monomer having a tertiary amino group with a quaternizing agent. The quaternized salts may be inorganic acid salts such as hydrochloride and sulfate, or organic acid salts such as acetate. Moreover, the quaternizing agent is methyl chloride, benzyl chloride, dimethyl sulfate, epichlorohydrin, or the like. They may be used in combination. Among them, the unsaturated monomer having a secondary amino group preferably comprises at least one of an unsaturated monomer having a tertiary amino group or a quaternized salt of the unsaturated monomer having a tertiary amino group, more preferably comprises at least one of (meth)acrylate having a tertiary amino group or a quaternized salt of the (meth)acrylate having a tertiary amino group, from the viewpoint of a high copolymerizability with the (a1) component, further preferably comprises N,N-dimethylaminoethyl (meth)acrylate or a quaternized salt of N,N-dimethylaminoethyl (meth) acrylate, particularly preferably comprises N, N-dimethylaminoethyl acrylate, N,N-dimethylaminoethyl acrylate benzyl chloride, or N,N-dimethylaminoethyl methacrylate benzyl chloride, from the viewpoint that an (A) component having a higher weight-average molecular weight can be obtained.

A content of the (a2) component is not particularly limited. The content of the (a2) component is preferably 1.5 mol % or more, more preferably 2 mol % or more, in all constituent monomers. Moreover, the content of the (a2) component is preferably 20 mol % or less in all constituent monomers. When the content of the (a2) component is within the above-described ranges, the (A) component becomes easily adsorbed on a pulp, and when it is dried to make paper, a high paper-strengthening effect tends to be exhibited.

The (a3) component is not particularly limited as long as it has anionic properties. By way of an example, the (a3) component is an unsaturated monomer having a carboxyl group such as (meth)acrylic acid, itaconic acid, itaconic anhydride, fumaric acid, and maleic acid; an unsaturated monomer having a sulfonic group such as vinyl sulfonic acid and methallyl sulfonic acid, or the like. Besides, these acids may be used as alkali metal salts such as sodium and potassium, or salts such as an ammonium salt. They may be used in combination.

A content of the (a3) component is not particularly limited. The content of the (a3) component is preferably 0.1 mol % or more, more preferably 0.5 mol % or more, further preferably 1 mol % or more, in all constituent monomers. Moreover, the content of the (a3) component is preferably 10 mol % or less in all constituent monomers. When the content of the (a3) component is within the above-described ranges, interaction with a cationic paper chemical (for example, aluminum sulfate, etc.) added during papermaking is enhanced, and a paper-strengthening effect of the obtained paper becomes more excellent.

In the present embodiment, from the viewpoint that, by increasing the weight-average molecular weight of the (A) component, a high paper-strengthening effect is exhibited when paper is produced using the obtained powdery paper-strengthening agent, it is preferable to comprise both an unsaturated monomer having a carboxyl group and an unsaturated monomer having a sulfonic group, and among them, it is more preferable to comprise acrylic acid, sodium acrylate, itaconic acid, methallyl sulfonic acid, and sodium methallylsulfonate.

Contents of the unsaturated monomer having a carboxyl group and the unsaturated monomer having a sulfonic group are not particularly limited. From the viewpoint that, by increasing the weight-average molecular weight of the (A) component, a high paper-strengthening effect is exhibited when paper is produced using the obtained powdery paper-strengthening agent, a molar ratio of (an unsaturated monomer having a carboxyl group)/(an unsaturated monomer having a sulfonic group)=about 99.9/0.1 to 50/50 is preferable, and a molar ratio of (an unsaturated monomer having a carboxyl group)/(an unsaturated monomer having a sulfonic group)=about 99/1 to 60/40 is more preferable.

The (a4) component is a component for introducing a branched structure into the (A) component. The (a4) component is not particularly limited. By way of an example, the (a4) component is N-alkyl (meth)acrylamide such as N-methyl (meth)acrylamide, N-ethyl (meth) acrylamide, N-isopropyl (meth) acrylamide, and N-t-butyl (meth)acrylamide; N,N-dialkyl (meth)acrylamide such as N,N-dimethyl (meth) acrylamide, N,N-diethyl (meth) acrylamide, and N,N-diisopropyl (meth)acrylamide; N,N′-alkylene bis (meth)acrylamide such as N,N′-methylene bis (meth)acrylamide and N,N′-ethylene bis (meth)acrylamide; a triallyl group-containing crosslinkable unsaturated monomer such as triallyl isocyanurate, triallyl trimellitate, triallylamine, and triallyl (meth)acrylamide; a (meth)acryloyl group-containing triazine such as 1,3,5-triacryloyl-1,3,5-triazine and 1,3,5-triacryloylhexahydro-1,3,5-triazine, or the like. They may be used in combination. Among them, from the viewpoints that a weight-average molecular weight of the (A) component can be increased, and a high paper-strengthening effect is exhibited when paper is produced using the obtained powdery paper-strengthening agent, the (a4) component preferably comprises at least one selected from the group consisting of N,N′-dialkyl (meth)acrylamide, N,N′-alkylene bis (meth) acrylamide, and (meth)acryloyl group-containing triazine, more preferably comprises N,N-dimethylacrylamide and N,N′-methylene bisacrylamide.

A content of the (a4) component is not particularly limited. By way of an example, the content of the (a4) component is preferably 0.001 mol % or more in all constituent monomers. Moreover, the content of the (a4) component is preferably 2 mol % or less, more preferably 1 mol % or less, further preferably 0.8 mol % or less, in all constituent monomers. When the content of the (a4) component is within the above-described ranges, the paper-strengthening agent can increase the weight-average molecular weight of the (A) component and exhibits a high paper-strengthening effect when paper is produced. In particular, when the content of the (a4) component is 1 mol % or less, the paper-strengthening agent easily suppresses gelation of a polymer produced by progress of an excessive cross-linking reaction, while increasing the weight-average molecular weight of the (A) component.

In the present embodiment, the (A) component may comprise a monomer (a5) (hereinafter, referred to as an (a5) component) other than the (a1) to (a4) components, as a constituent monomer. The (a5) component is not particularly limited. By way of an example, the (a5) component include an aromatic unsaturated monomer such as styrene, α-methylstyrene, and vinyltoluene; alkyl (meth)acrylate such as methyl (meth)acrylate, ethyl (meth)acrylate, n-propyl (meth)acrylate, n-butyl (meth)acrylate, 2-ethylhexyl (meth)acrylate, and cyclohexyl (meth)acrylate; carboxylic acid vinyl ester such as vinyl acetate and vinyl propionate; nitrile such as acrylonitrile; mercaptans such as 2-mercaptoethanol and n-dodecyl mercaptan; alcohol such as ethanol, isopropyl alcohol, and n-pentyl alcohol; an aromatic compound such as α-methylstyrene dimer, ethylbenzene, isopropylbenzene, and cumene; carbon tetrachloride, and the like. They may be used in combination.

When the (A) component comprise an (a5) component, a content of the (a5) component is not particularly limited. By way of an example, the content of the (a5) component is less than 5 mol % in all constituent monomers.

In the production of the (A) component, organic acids such as citric acid, succinic acid, and oxalic acid; inorganic acid such as hydrochloric acid, sulfuric acid, and phosphoric acid; inorganic bases such as sodium hydroxide, potassium hydroxide, and calcium hydroxide; additives such as an anti-foaming agent and an antioxidant may be added. They may be used in combination. A content of these additives is preferably 5 parts by mass or less based on 100 parts by mass of all constituent monomers.

A method of producing the powdery paper-strengthening agent of the present embodiment is not particularly limited. By way of an example, the powdery paper-strengthening agent can be obtained by a production method through a step of dissolving an (a1) component, an (a2) component, an (a3) component, and an (a4) component in a solvent and polymerizing them (hereinafter, referred to as “solution polymerization”), and then a step of drying and pulverizing the obtained (A) component.

The solution polymerization is a method of polymerizing the (a1) to (a4) components, and if necessary, the component (a5) and the above-described additives in a solvent in the presence of a polymerization initiator to obtain a solution of a (meth)acrylamide-based polymer. The method is preferably a method using only a dropping polymerization method or a mixed method of a simultaneous polymerization method (in which a monomer mixed solution is charged in a batch) and the dropping polymerization method, from the viewpoint that, for example, the obtained powdery paper-strengthening agent shows a maximum value of turbidity which will be described later, and as a result, it is excellent in paper-strengthening effect.

The dropping polymerization method is a method of dropping a monomer mixed solution into a reaction system in which a solvent such as water is charged in advance, and examples of the method using only the dropping polymerization method include the followings (1) to (3). Besides, the dropping may be continuously performed, or the dropping may be stopped in the middle to perform polymerization for a certain period of time, and then the dropping may be restarted.

(1) A method of dropping a monomer mixed solution in which all monomer components are mixed.

(2) A method of separately preparing two or more kinds of monomer mixed solutions having different monomer compositions and then dropping them at the same time.

(3) A method of separately preparing two or more kinds of monomer mixed solutions having different monomer compositions and then dropping them in turn.

Moreover, examples of a combined method of the simultaneous polymerization method and the dropping polymerization method include the followings (4) to (7).

(4) A method of separately co-polymerizing two or more kinds of monomer mixed solutions having different monomer compositions and then mixing the polymers.

(5) A method of co-polymerizing one or more kinds of monomer mixed solutions and then dropping the remaining monomer mixed solutions.

(6) A method of co-polymerizing one or more kinds of monomer mixed solutions, in the middle of which the remaining monomer mixed solutions are dropped and polymerized.

(7) A method of dropping and polymerizing one or more kinds of monomer mixed solutions, adding the remaining monomer mixed solutions all at once, and then co-polymerizing them.

Here, when preparing two or more kinds of monomer mixed solutions, it is more preferable to perform such operations that concentrations of the (a2) component and the (a3) component involved in reaction are increased in any of the monomer mixed solutions, such as increasing amounts of the (a2) component and the (a3) component in some mixed solutions to subject these mixed solutions to reaction in sequence, or adding the (a2) component and the (a3) component at a certain point during the polymerization reaction.

Examples of the solvent include water, an organic solvent, and the like. They may be used in combination. The organic solvent is not particularly limited. By way of an example, the organic solvent is alcohol such as methanol, ethanol, n-propyl alcohol, isopropyl alcohol, n-butyl alcohol, sec-butyl alcohol, t-butyl alcohol, isobutyl alcohol, n-hexyl alcohol, n-octyl alcohol, ethylene glycol, propylene glycol, diethylene glycol, triethylene glycol, and diacetone alcohol; ether such as ethylene glycol monobutyl ether, propylene glycol monomethyl ether, and propylene glycol monoethyl ether, or the like. Among them, water is preferable as the solvent from the viewpoint that the (a1) to (a5) components and the above-described additives are easily dissolved.

The polymerization initiator is not particularly limited. By way of an example, the polymerization initiator is persulfate such as ammonium persulfate, potassium persulfate, and sodium persulfate; an azo-based compound such as 2,2′-azobis(2-amidinopropane) hydrochloride and 2,2′-azobis[2 (2-imidazoline-2-yl) propane] hydrochloride; hydrogen peroxide, or the like. They may be used in combination. Among them, the polymerization initiator is preferably ammonium persulfate, potassium persulfate, or 2,2′-azobis(2-amidinopropane) hydrochloride, from the viewpoint of sufficiently advancing solution polymerization. Moreover, a method of adding the polymerization initiator is not particularly limited. By way of an example, the method of adding the polymerization initiator can be appropriately selected from batch addition, partial addition, continuous dropping, and the like. Moreover, a content of the polymerization initiator is not particularly limited. The content of the polymerization initiator is preferably about 0.001 to 5 parts by mass, more preferably about 0.01 to 1 parts by mass, based on 100 parts by mass of the (a1) to (a5) components.

A polymerization condition is not particularly limited. By way of an example, the polymerization condition is of a temperature at about 50 to 100° C. and a time of about 1 to 8 hours.

Additives such as an anti-foaming agent, an antioxidant, a preservative, a chelating agent, a water-soluble aluminum compound, a Glauber's salt, urea, and polysaccharide may be further added to the solution of the (A) component.

The powdery paper-strengthening agent of the present embodiment is obtained by drying and pulverizing the (A) component. Besides, drying and pulverization may be performed at the same time, or pulverization may be performed after drying.

A drying method is not particularly limited. By way of an example, the drying method is a hot air drying with a circulation dryer, etc.; a conduction heat transfer drying such as a vacuum drying and a dryer drying; a radiant heat drying with infrared rays, electromagnetic waves, etc., or the like. Moreover, a drying condition is not particularly limited. By way of an example, the drying condition is at about 60 to 150° C. (preferably 80 to 130° C.) for about 0.5 to 10 minutes (preferably 0.5 to 5 minutes). Besides, the dryer drying is not particularly limited. By way of an example, the dryer drying is by way of a double drum dryer, a single drum dryer, a twin drum dryer, or the like.

A pulverizing method is not particularly limited. By way of an example, the pulverizing method is by way of a grinder (a stone mill type grinder), a high pressure homogenizer or ultrahigh pressure homogenizer, a high pressure collision type crusher, a ball mill, a bead mill, a vibration mill, or the like.

Moreover, the powdery paper-strengthening agent of the present embodiment can also be obtained by a production method through a step of dropping or charging the (A) component obtained by the above-described solution polymerization into an organic solvent to form a precipitate and a step of drying and pulverizing the (A) component obtained as a precipitate. The method has an advantage that decomposition of the (A) component is easily suppressed.

The organic solvent is not particularly limited. By way of an example, the organic solvent is preferably an organic solvent miscible with water, more preferably monoalcohol such as methanol, ethanol, n-propyl alcohol, and isopropyl alcohol; ketone such as acetone, ethyl methyl ketone, and diethyl ketone; ether such as diethyl ether, ethyl propyl ether, di-n-propyl ether, n-butyl ethyl ether, di-n-butyl ether, and t-butyl ethyl ether, further preferably methanol, acetone, or diethyl ether. The organic solvent may be used in combination.

An amount of the organic solvent miscible with water to be used is not particularly limited. The amount of the organic solvent used is preferably about 300 to 10,000 parts by mass based on 100 parts by mass of the solution of the (A) component, from the viewpoint of facilitating more efficient precipitation of the (A) component.

Moreover, in addition to the above-described organic solvent miscible with water, an organic solvent immiscible with water may be mixed. The organic solvent immiscible with water is not particularly limited. By way of an example, the organic solvent immiscible with water is ester such as methyl acetate and ethyl acetate; a saturated hydrocarbon such as n-pentane, n-hexane, and n-heptane, or the like.

They may be used in combination. Furthermore, an amount of the organic solvent immiscible with water is not particularly limited. By way of an example, the amount of the organic solvent immiscible with water is preferably less than 50 parts by mass based on 100 parts by mass of the solution of the (A) component.

After forming a precipitate, the obtained precipitate of the (A) component can be recovered by being filtered with a wire mesh or the like. The recovered precipitate of the (A) component is dried since it volatilizes the organic solvent. The drying method is not particularly limited. By way of an example, the drying method is the above-described hot air drying, conduction heat transfer drying, radiant heat drying, or the like. Moreover, a drying condition is, for example, at a temperature of about 50 to 150° C. (preferably 50 to 105° C.) for about 0.5 to 240 minutes (preferably 1 to 180 minutes).

The powdery paper-strengthening agent of the present embodiment can be obtained by pulverizing a dried (A) component by various known methods. A pulverizing method is, for example, similar as described above.

An average particle size of the powdery paper-strengthening agent of the present embodiment is not particularly limited. By way of an example, the average particle size of the powdery paper-strengthening agent is preferably about 0.01 to 2 mm from the viewpoint of making it easily soluble in a solvent such as water.

A weight-average molecular weight of the (A) component (a value obtained by gel permeation chromatography (GPC) method) is 1,000,000 or more, preferably 1,500,000 or more, more preferably 2,000,000 or more, further preferably 2,500,000 or more. Moreover, the weight-average molecular weight of the (A) component is 7,000,000 or less, preferably 6,000,000 or less, more preferably 5,500,000 or less, further preferably 5,000,000 or less. When the weight-average molecular weight is less than 1,000,000, the powdery paper-strengthening agent tends to have a low paper-strengthening effect. On the other hand, when the weight-average molecular weight exceeds 7,000,000, the (A) component easily causes over-aggregation, deteriorating a formation of paper when the powdery paper-strengthening agent is added to a pulp slurry.

The powdery paper-strengthening agent of the present embodiment has a maximum value of turbidity of 10 to 2500 NTU at pH 3 to 9 of an aqueous solution having a concentration of 1% by mass of the (A) component dissolved in a calcium chloride aqueous solution having an electrical conductivity of 4 mS/cm at 25° C. The numerical value means that, when the powdery paper-strengthening agent is dissolved in a calcium chloride aqueous solution having an electrical conductivity of 4 mS/cm at 25° C. to prepare an aqueous solution having a concentration of 1% by mass of the (A) component, a maximum value of turbidity at pH 3 to 9 of the aqueous solution is 10 to 2500 NTU. When turbidity is less than 10 NTU, the powdery paper-strengthening agent has a weak cohesiveness and easily becomes insufficient in paper-strengthening effect of paper. On the other hand, when it exceeds 2500 NTU, the (A) component is over-aggregated, deteriorating the formation of paper when the powdery paper-strengthening agent is added to the pulp slurry. Moreover, the maximum value of turbidity is preferably 10 to 2000 NTU.

Turbidity is a degree of turbidness, which is a value obtained by measuring a scattered light at 180 degrees utilizing an infrared light of 900 nm with ANALITE NEPHELOMETER 152 (manufactured by McVan Instruments). The measured value is a relative evaluation value with respect to a standard substance (Formazine standard solution 400 NTU, manufactured by Wako Pure Chemical Industries, Ltd.).

Water (aqueous solution) used for measuring turbidity is a calcium chloride aqueous solution having an electrical conductivity of 4 mS/cm at 25° C. Water used for preparing a calcium chloride aqueous solution is preferably a deionized water. This deionized water is water having an electrical conductivity of 0.2 mS/cm or less through an ion exchange resin. A reason for using the above-described calcium chloride aqueous solution is that calcium ions are contained in a white water when papermaking, and further, calcium carbonate is also added as a filler to a pulp slurry. When this white water and the pulp slurry are mixed, a large amount of calcium ions are present in the slurry liquid, so that, by using calcium chloride that dissolves in the deionized water, an environment close to that for papermaking can be created. Moreover, another reason for using the above-described aqueous solution is that calcium ions have a great effect of shielding ionicity of a pulp, a paper-strengthening agent, etc. in a papermaking system.

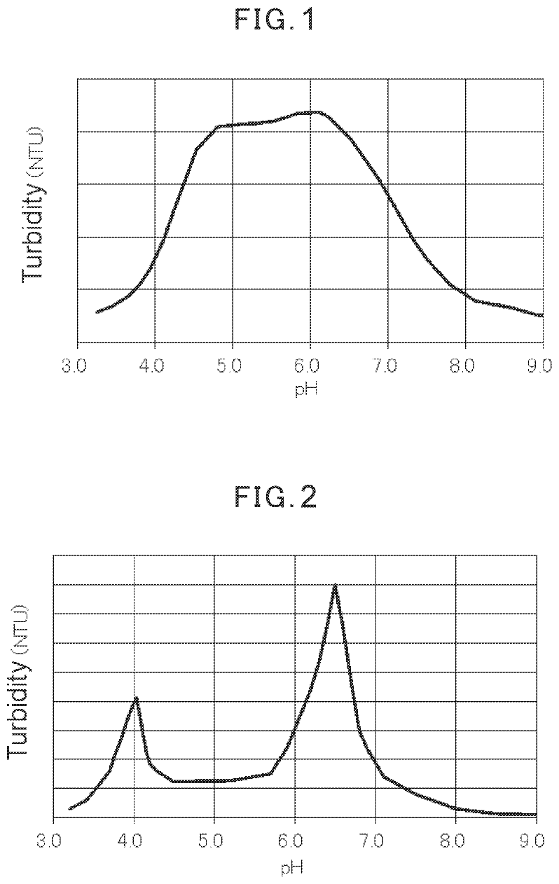

The above-described turbidity correlates with a degree to which the (A) component forms a polyion complex (PIC), whose value varies depending on pH. Since the (A) component has anionic and cationic functional groups in its molecule, pH of the solution approximates around an isoelectric point to form a PIC. When the (A) component begins to form a PIC, the solution becomes turbid. FIG. 1 is a drawing having “one peak” of a distribution of turbidity. As for the distribution of turbidity, as shown in FIG. 1, when the pH is changed, turbidity of the solution becomes gradually thicker at first, and the turbidity value continues to increase as well. After reaching the maximum value, the turbidity becomes lighter, and the turbidity value also decreases (this distribution is referred to as “one peak”, see FIG. 1). Moreover, when an excessive PIC is formed, precipitates are generated in the solution at a certain point in time, and therefore the turbidness becomes lighter, thereby decreasing the turbidity value, and when the pH is further increased, the precipitates gradually disappear, and therefore the turbidness becomes thicker again, which may increase the turbidity value. FIG. 2 is a drawing having “two peaks” of a distribution of turbidity. In this case, as shown in FIG. 2, a turbidity distribution when pH is changed from 3 to 9 has two peaks (this distribution is referred to as “two peaks”, see FIG. 2). The powdery paper-strengthening agent of the present embodiment exhibits an excellent paper-strengthening effect as long as one of the peaks has a maximum value of 10 to 2500 NTU. Besides, in the present embodiment, a distribution of turbidity preferably has one peak from the viewpoint of also improving a formation of paper.

Other physical properties of the powdery paper-strengthening agent of the present embodiment are not particularly limited. By way of an example, a viscosity of a powdery paper-strengthening agent aqueous solution (temperature at 25° C.) having a concentration of 20% by mass is preferably about 1,000 to 20,000 mPa·s, more preferably about 4,000 to 15,000 mPa·s. Besides, a viscosity is a value measured with a B-type viscometer (Brook Field viscometer).

The paper-strengthening agent solution of the present embodiment comprises a powdery paper-strengthening agent and water.

A method of preparing a paper-strengthening agent solution is not particularly limited. By way of an example, as the method of preparing a paper-strengthening agent solution, water may be added to the powdery paper-strengthening agent in a batch to be mixed, water may be divided and added to be mixed, or a powdery paper-strengthening agent may be added to water to be mixed. A mixing means is not particularly limited. By way of an example, the mixing means is by way of a stirrer, a mixer, a homogenizer, or the like. Moreover, heating may be performed at the time of mixing, and the temperature is usually preferably about 5 to 40° C., more preferably about 10 to 30° C.

A solid content concentration of the paper-strengthening agent solution is not particularly limited. The solid content concentration is usually 0.01 to 2% by mass. Moreover, a viscosity of the paper-strengthening agent solution at a temperature of 25° C. in an aqueous solution having a concentration of 1% by mass is about 1 to 100 mPa·s. Besides, a viscosity is a value measured by a Brook Field viscometer (B-type viscometer).

Various additives may be compounded in the paper-strengthening agent solution, if necessary. The additives are acids, alkalis, anti-foaming agents, preservatives, chelating agents such as citric acid, water-soluble aluminum compounds, Glauber's salts, urea, polysaccharides, or the like.

The paper of the present embodiment is a paper obtained by using the above-described paper-strengthening agent solution. Examples of a method of producing paper include, for example, adding a paper-strengthening agent solution into a raw material pulp slurry, coating it on a surface of a base paper, or the like. Besides, the paper-strengthening agent solution is preferably diluted with water, and a concentration of the diluted aqueous solution is preferably 0.01 to 3% by mass.

In the case of adding to the raw material pulp slurry, it is a paper-strengthening agent solution that is added to the pulp slurry for papermaking. An amount of the paper-strengthening agent solution used (in terms of a solid content) is not particularly limited. By way of an example, the amount of the paper-strengthening agent solution used (in terms of the solid content) is about 0.01 to 4% by mass based on a dry weight of a pulp. Moreover, a type of the pulp is not particularly limited. By way of an example, the type of the pulp is of a chemical pulp such as Leaf Bleached Kraft Pulp (LBKP) and Needle Bleached Kraft Pulp (NBKP); a mechanical pulp such as Ground Pulp (GP), Refiner Ground Pulp (RGP), and Thermomechanical Pulp (TMP); a recycled pulp such as a waste corrugated fiberboard, or the like. Besides, when adding a paper-strengthening agent solution, additionally, pH adjusters such as sulfuric acid and sodium hydroxide; retention aids such as aluminum sulfate; paper-making chemicals such as a sizing agent, a retention agent, and a wet paper-strengthening agent; fillers such as talc, clay, kaolin, titanium dioxide, and calcium carbonate, and the like may be added.

In the case of coating on the surface of the base paper, it is a paper-strengthening agent solution that is coated on the surface of the base paper by various known means. A viscosity of the paper-strengthening agent solution is usually 1 to 40 mPa·s at a temperature of 50° C. A type of the base paper is preferably of paper made from a wood cellulose fiber. A coating means is not particularly limited. By way of an example, the coating means is by way of a bar coater, a knife coater, an air knife coater, a calender, a gate roll coater, a blade coater, a two-roll size press, a rod metering, or the like. Moreover, a coating amount of the paper-strengthening agent solution (in terms of the solid content) is not particularly limited. The coating amount of the paper-strengthening agent solution (in terms of the solid content) is usually about 0.001 to 2 g/m², preferably about 0.005 to 1 g/m².

The paper of the present embodiment can be used as various products. By way of an example, the paper of the present embodiment can be appropriately used as a coated base paper, newspaper, linerboard, corrugated medium, paper tube, printing and writing paper, form paper, PPC paper, cup base paper, inkjet paper, heat-sensitive paper, or the like.

(1) A powdery paper-strengthening agent comprising an amphoteric (meth)acrylamide-based polymer (A) having a weight-average molecular weight of 1,000,000 to 7,000,000, wherein the amphoteric (meth)acrylamide-based polymer (A) comprises, as constituent monomers, (meth)acrylamide which is an (a1) component, a cationic unsaturated monomer which is an (a2) component, an anionic unsaturated monomer which is an (a3) component, and a crosslinkable unsaturated monomer which is an (a4) component, and wherein an aqueous solution, in which the amphoteric (meth)acrylamide-based polymer (A) is dissolved in a calcium chloride aqueous solution having an electrical conductivity of 4 mS/cm at 25° C. so as to be 1% by weight, has a maximum turbidity of 10 to 2500 NTU at pH 3 to 9.

(2) The powdery paper-strengthening agent of (1), wherein a content of the (a1) component is 70 to 98 mol % in the constituent monomers, wherein a content of the (a2) component is 1.5 to 20 mol % in the constituent monomers, wherein a content of the (a3) component is 0.1 to 10 mol % in the constituent monomers, and wherein a content of the (a4) component is 0.001 to 2 mol % in the constituent monomers.

(3) The powdery paper-strengthening agent of (1) or (2), wherein the (a2) component comprises at least one of an unsaturated monomer having a tertiary amino group and a quaternized salt of the unsaturated monomer having a tertiary amino group.

(4) The powdery paper-strengthening agent of any one of (1) to (3), wherein the (a3) component comprises an unsaturated monomer having a carboxyl group and an unsaturated monomer having a sulfonic group.

(5) A paper-strengthening agent solution comprising a powdery paper-strengthening agent of any one of (1) to (4) and water.

(6) Paper obtained by using a paper-strengthening agent solution of (5).

### EXAMPLE

Hereinafter, the present invention will be described with reference to Examples. The present invention is not limited these Examples. Besides, unless otherwise specified, “part(s)” and “%” in Examples and Comparative examples are based on weight.

Abbreviations of compounds are shown below.

AM: Acrylamide

DM: N,N-dimethylaminoethyl methacrylate

DML: N,N-dimethylaminoethyl methacrylate benzyl chloride

BQ: N,N-dimethylaminoethyl acrylate benzyl chloride

IA: Itaconic acid

AA: Acrylic acid

SMAS: Sodium methallylsulfonate

DMAA: N,N-dimethylacrylamide

MBAA: N,N′-methylenebisacrylamide

TAF: 1,3,5-triacryloylhexahydro-1,3,5-triazine

APS: Ammonium persulfate

V-50: 2,2′-azobis(2-amidinopropane) hydrochloride

### <Weight-Average Molecular Weight>

A weight-average molecular weight and a molecular weight distribution were measured by gel permeation chromatography (GPC) method under the following measurement conditions.

Column: One Guard column PWXL and two GMPWXL manufactured by Tosoh Corporation

Eluent: Phosphate buffer (0.05 mol/L phosphoric acid (manufactured by FUJIFILM Wako Pure Chemical Corporation)+0.13 mol/L sodium dihydrogen phosphate (manufactured by FUJIFILM Wako Pure Chemical Corporation) aqueous solution, pH: about 2.5)

Flow rate: 0.8 mL/min

Temperature: 40° C.

RI detector: Shodex RI-101 manufactured by Showa Denko K.K.

MALS detector: DAWN HELEOS-II manufactured by Wyatt Technology

Measurement sample: Measured by diluting with the above-described eluent so that a concentration of the (A) component became 0.1%.

### <Viscosity>

A deionized water was added to the powdery paper-strengthening agent and dissolved so that a solid content concentration of the (A) component became 20.0%. A viscosity of a sample at a temperature of 25° C. was measured using a B-type viscometer (manufactured by Toki Sangyo Co., Ltd.).

### <Turbidity>

Turbidity meter: ANALITE NEPHELOMETER 152 (manufactured by McVan Instruments)
Infrared wavelength: 900 nm
Standard substance: Formazine standard solution (400 NTU, manufactured by Wako Pure Chemical Industries, Ltd.)
Sample concentration: 1% (solid content concentration of (A) component)
Solvent: Water having an electrical conductivity of 4 mS/cm at 25° C. in which a deionized water was prepared with calcium chloride
Sample temperature: 25° C.

### (Measuring Method of Turbidity)

An aqueous solution obtained by diluting the powdery paper-strengthening agent with the above-described solvent to 1% at a solid content concentration of the (A) component was stirred with a stirrer at 500 rpm. For increasing pH, a 1% sodium hydroxide aqueous solution, or for decreasing pH, a 1% sulfuric acid aqueous solution was gradually dropped so that the pH each changed by 0.1, to measure a value of turbidity with respect to the pH. When the turbidity value was not stable, we waited until it became stable, and a numerical value at the stable point was taken as a turbidity value. A maximum value was read in a turbidity distribution (peak) obtained by the measurement. Besides, when the distribution (peak) of turbidity had two peaks, one with a higher value was taken as a maximum value. Table 3 shows the maximum value and distribution of turbidity.

### Example 1

500.8 parts of ion-exchanged water were put into a reactor equipped with a stirrer, a thermometer, a reflux cooling tube, a nitrogen gas introduction tube, and three dropping funnels, removed of oxygen in a reaction system through nitrogen gas, and then heated to 90° C. 98.3 parts (27.0 mol %) of AM, 48.3 parts (6.0 mol %) of DM, 1.6 parts (0.2 mol %) of SMAS, 23.6 parts of 62.5% sulfuric acid, 0.25 parts (0.05 mol %) of DMAA, 0.4 parts (0.05 mol %) of MBAA, and 300.1 parts of ion-exchanged water were charged into the dropping funnel (1), and pH was adjusted to around 3.0 with sulfuric acid (a monomer mixed solution (I)). In addition, 233.0 parts (64.0 mol %) of AM, 16.7 parts (2.5 mol %) of IA, 0.8 parts (0.1 mol %) of SMAS, 0.25 parts (0.05 mol %) of DMAA, 0.4 parts (0.05 mol %) of MBAA, and 546.1 parts of ion-exchanged water were charged into the dropping funnel (2), and pH was adjusted to around 3.0 with sulfuric acid (a monomer mixed solution (II)). 0.6 parts of APS and 180 parts of ion-exchanged water were charged into the dropping funnel (3). Next, a catalyst in a system was dropped with the dropping funnel (3) over about 3 hours. In parallel, the monomer mixed solution (I) in the dropping funnel (1) and the monomer mixed solution (II) in the dropping funnel (2) were dropped in this order at a constant flow rate over about 3 hours. After completion of the dropping, 0.4 parts of APS and 10 parts of ion-exchanged water were charged and kept warm for 1 hour, and 117 parts of ion-exchanged water were charged to obtain an aqueous solution of an (A-1) component. Besides, molar ratios of all monomer components are shown in Table 1, and molar ratios of monomer components charged in respective monomer mixed solutions are shown in Table 2.

Next, 100 parts of the obtained aqueous solution of the (A-1) component were dropped into 1,500 parts of methanol, and then the mixture was filtered through a wire mesh (100 mesh, SUS304) to obtain a precipitate. The mixture was dried in a circulation dryer at a temperature of 105° C. for 3 hours and then pulverized in a ball mill for 2 minutes to obtain a powdery paper-strengthening agent. A weight-average molecular weight, a viscosity, and a turbidity (maximum value, distribution) of each of the obtained powdery paper-strengthening agents are shown in Table 3 (the same applies hereinafter).

### Examples 2 to 17, 20 to 21, Comparative Examples 1 to 5

The powdery paper-strengthening agents were obtained in the similar manner as in Example 1 with compositions shown in Tables 1 and 2.

### Example 18

492.7 parts of ion-exchanged water, 44.8 parts (12.5 mol %) of AM, 23.8 parts (3 mol %) of DM, 23.8 parts (1 mol %) of 60% DML aqueous solution, 0.8 parts (0.1 mol %) of SMAS, and 11.6 parts of 62.5% sulfuric acid were charged into the similar reactor vessel as in Example 1, and pH was adjusted to around 3.0 with sulfuric acid (a monomer mixed solution (I)). The monomer in the reactor vessel was stirred and dissolved, and the temperature was raised to 60° C. while injecting a nitrogen gas to remove oxygen in the reaction system. 0.6 g of ammonium persulfate was added with stirring to initiate polymerization. Furthermore, as a next step, 52.0 parts (14.5 mol %) of AM, 15.8 parts (2 mol %) of DM, 0.8 parts (0.1 mol %) of SMAS, 7.7 parts of 62.5% sulfuric acid, 0.25 parts (0.05 mol %) of DMAA, 0.39 parts (0.05 mol %) of MBAA, and 170.3 parts of ion-exchanged water were charged into the dropping funnel (1), and pH was adjusted to around 3.0 with sulfuric acid (a monomer mixed solution (II)). In addition, 229.3 parts (64.0 mol %) of AM, 16.4 parts (2.5 mol %) of IA, 0.8 parts (0.1 mol %) of SMAS, 0.25 parts (0.05 mol %) of DMAA, 0.39 parts (0.05 mol %) of MBAA, and 635.5 parts of ion-exchanged water were charged into the dropping funnel (2), and pH was adjusted to around 3.0 with sulfuric acid (a monomer mixed solution (III)). 0.6 parts of APS and 180 parts of ion-exchanged water were charged into the dropping funnel (3). Next, a catalyst in a system was dropped with the dropping funnel (3) over about 3 hours from the time when the temperature inside the flask reached 65° C. In parallel, the monomer mixed solution (II) in the dropping funnel (1) and the monomer mixed solution (III) in the dropping funnel (2) were dropped in this order at a constant flow rate over about 3 hours. After completion of the dropping, 0.4 parts of APS and 10 parts of ion-exchanged water were charged and kept warm for 1 hour, and 149 parts of ion-exchanged water were charged to obtain an aqueous solution of an (A-18) component.

Next, 100 parts of the obtained aqueous solution of the (A-18) component were dropped into 1,500 parts of methanol, and then the mixture was filtered through a wire mesh (100 mesh, SUS304) to obtain a precipitate. The mixture was dried in a circulation dryer at a temperature of 105° C. for 3 hours and then pulverized in a ball mill for 2 minutes to obtain a powdery paper-strengthening agent.

### Example 19

1534 parts of ion-exchanged water, 310 parts (77.5 mol %) of AM, 68 parts (17.0 mol %) of DM, 4 parts (1.0 mol %) of IA, 0.4 parts (0.1 mol %) of SMAS, 33.2 parts of 62.5% sulfuric acid, and 1.6 parts (0.4 mol %) of DMAA were charged into the similar reactor vessel as in Example 1, and pH was adjusted to around 3.0 with sulfuric acid. The monomer in the reactor vessel was stirred and dissolved, and the temperature was raised to 60° C. while injecting a nitrogen gas to remove oxygen in the reaction system. 0.6 parts of APS was added with stirring to initiate polymerization. Next, when the temperature inside the flask reached 75° C., 16 parts (4.0 mol %) of IA was charged. After 1 hour, 0.4 part of APS and 10 parts of ion-exchanged water were charged, and the mixture was polymerized for 1 hour. 130 parts of ion-exchanged water were charged to obtain an aqueous solution of an (A-19) component.

Next, 100 parts of the obtained aqueous solution of the (A-19) component were dropped into 1,500 parts of methanol, and then the mixture was filtered through a wire mesh (100 mesh, SUS304) to obtain a precipitate. The mixture was dried in a circulation dryer at a temperature of 105° C. for 3 hours and then pulverized in a ball mill for 2 minutes to obtain a powdery paper-strengthening agent.

### Comparative Example 6

1560.2 parts of ion-exchanged water, 326 parts (91.0 mol %) of AM, 39.6 parts (5.0 mol %) of DM, 23.8 parts (1.0 mol %) of 60% DML aqueous solution, 16.4 parts (2.5 mol %) of IA, 2.4 parts (0.3 mol %) of SMAS, 19.4 parts of 62.5% sulfuric acid, 0.5 parts (0.1 mol %) of DMAA, and 0.78 parts (0.1 mol %) of MBAA were charged into the similar reactor vessel as in Example 1, and pH was adjusted to around 3.0 with sulfuric acid. The monomer in the reactor vessel was stirred and dissolved, and the temperature was raised to 60° C. while injecting a nitrogen gas to remove oxygen in the reaction system. 0.6 parts of APS was added with stirring to initiate polymerization. Then, the polymerization was held at 90° C. for 3 hours to be completed. 74 parts of ion-exchanged water were charged to obtain an aqueous solution of an (A-27) component.

Next, 100 parts of the obtained aqueous solution of the (A-27) component were dropped into 1,500 parts of methanol, and then the mixture was filtered through a wire mesh (100 mesh, SUS304) to obtain a precipitate. The mixture was dried in a circulation dryer at a temperature of 105° C. for 3 hours and then pulverized in a ball mill for 2 minutes to obtain a powdery paper-strengthening agent.

TABLE 1

| | (a1) component | (a2) component | | | (a3) component | | | (a4) component | | |
|---|---|---|---|---|---|---|---|---|---|---|
| | AM | DM | DML | BQ | IA | AA | SMAS | DMAA | MBAA | TAF |
| Example 1 | 91.0 | 6.0 | — | — | 2.5 | — | 0.3 | 0.1 | 0.1 | — |
| Example 2 | 91.0 | — | 6.0 | — | 2.5 | — | 0.3 | 0.1 | 0.1 | — |
| Example 3 | 91.0 | — | — | 6.0 | 2.5 | — | 0.3 | 0.1 | 0.1 | — |
| Example 4 | 91.0 | 3.0 | 2.0 | 1.0 | 2.5 | — | 0.3 | 0.1 | 0.1 | — |
| Example 5 | 91.0 | 5.0 | 1.0 | — | 2.5 | — | 0.3 | 0.1 | 0.1 | — |
| Example 6 | 90.5 | 5.0 | 1.0 | — | 2.0 | 1.0 | 0.3 | 0.1 | 0.1 | — |
| Example 7 | 88.5 | 5.0 | 1.0 | — | — | 5.0 | 0.3 | 0.1 | 0.1 | — |
| Example 8 | 91.0 | 5.0 | 1.0 | — | 1.5 | — | 1.3 | 0.1 | 0.1 | — |
| Example 9 | 90.7 | 5.0 | 1.0 | — | 2.5 | — | 0.3 | 0.5 | — | — |
| Example 10 | 91.0 | 5.0 | 1.0 | — | 2.5 | — | 0.3 | 0.1 | — | 0.1 |
| Example 11 | 90.4 | 5.0 | 1.0 | — | 2.5 | — | — | 1.0 | 0.1 | — |
| Example 12 | 93.0 | 2.0 | 2.0 | — | 2.5 | — | 0.3 | 0.1 | 0.1 | — |
| Example 13 | 86.0 | 5.5 | 5.0 | 0.5 | 2.5 | — | 0.3 | 0.1 | 0.1 | — |
| Example 14 | 85.0 | 5.0 | 5.0 | 0.5 | 4.0 | — | 0.3 | 0.1 | 0.1 | — |
| Example 15 | 87.8 | 2.0 | 0.5 | — | 1.0 | 8.0 | 0.5 | 0.1 | 0.1 | — |
| Example 16 | 92.5 | 6.0 | — | — | 1.0 | — | 0.3 | 0.1 | 0.1 | — |
| Example 17 | 92.397 | 6.0 | — | — | 1.0 | — | 0.6 | — | — | 0.003 |
| Example 18 | 91.0 | 5.0 | 1.0 | — | 2.5 | — | 0.3 | 0.1 | 0.1 | — |
| Example 19 | 77.5 | 17.0 | — | — | 5.0 | — | 0.1 | 0.4 | — | — |
| Example 20 | 89.3 | 1.0 | — | — | 1.0 | 8.0 | 0.5 | 0.1 | 0.1 | — |
| Example 21 | 89.0 | 4.0 | 4.0 | — | 2.5 | — | 0.3 | 0.1 | 0.1 | — |
| Comparative | 97.0 | — | — | — | 2.5 | — | 0.3 | 0.1 | 0.1 | — |
| example 1 | | | | | | | | | | |
| Comparative | 93.8 | 6.0 | — | — | — | — | — | 0.1 | 0.1 | — |
| example 2 | | | | | | | | | | |
| Comparative | 90.5 | 6.0 | — | — | 2.5 | — | 1.0 | — | — | — |
| example 3 | | | | | | | | | | |
| Comparative | 88.0 | 6.0 | — | — | 2.5 | — | — | 2.5 | 1.0 | — |
| example 4 | | | | | | | | | | |
| Comparative | 81.5 | — | 6.0 | — | 12.0 | — | 0.2 | 0.2 | — | 0.1 |
| example 5 | | | | | | | | | | |
| Comparative | 91.0 | 5.0 | 1.0 | — | 2.5 | — | 0.3 | 0.1 | 0.1 | — |
| example 6 | | | | | | | | | | |

TABLE 2

| | Monomer composition in monomer mixed solution (I) | | | | | | | | | | | | | |
|---|---|---|---|---|---|---|---|---|---|---|---|---|---|---|
| | (a1) | | | | | | | | | | | | | |
| | component | (a2) component | | | | (a3) component | | | | (a4) component | | | | |
| | AM | DM | DML | BQ | Total | IA | AA | SMAS | Total | DMAA | MBAA | TAF | Total | Total |
| Example 1 | 27.0 | 6.0 | — | — | 6.0 | — | — | 0.2 | 0.2 | 0.05 | 0.05 | — | 0.1 | 33.3 |
| Example 2 | 27.0 | — | 6.0 | — | 6.0 | — | — | 0.2 | 0.2 | 0.05 | 0.05 | — | 0.1 | 33.3 |
| Example 3 | 27.0 | — | — | 6.0 | 6.0 | — | — | 0.2 | 0.2 | 0.05 | 0.05 | — | 0.1 | 33.3 |
| Example 4 | 27.0 | 3.0 | 2.0 | 1.0 | 6.0 | — | — | 0.2 | 0.2 | 0.05 | 0.05 | — | 0.1 | 33.3 |
| Example 5 | 27.0 | 5.0 | 1.0 | — | 6.0 | — | — | 0.2 | 0.2 | 0.05 | 0.05 | — | 0.1 | 33.3 |
| Example 6 | 27.0 | 5.0 | 1.0 | — | 6.0 | — | — | 0.2 | 0.2 | 0.05 | 0.05 | — | 0.1 | 33.3 |
| Example 7 | 27.0 | 5.0 | 1.0 | — | 6.0 | — | — | 0.2 | 0.2 | 0.05 | 0.05 | — | 0.1 | 33.3 |
| Example 8 | 27.0 | 5.0 | 1.0 | — | 6.0 | — | — | 1.0 | 1.0 | 0.05 | 0.05 | — | 0.1 | 33.3 |
| Example 9 | 26.9 | 5.0 | 1.0 | — | 6.0 | — | — | 0.2 | 0.2 | 0.2 | — | — | 0.2 | 33.3 |
| Example 10 | 27.0 | 5.0 | 1.0 | — | 6.0 | — | — | 0.2 | 0.2 | 0.05 | — | 0.05 | 0.1 | 33.3 |
| Example 11 | 26.8 | 5.0 | 1.0 | — | 6.0 | — | — | — | — | 0.25 | 0.05 | — | 0.3 | 33.3 |
| Example 12 | 29.0 | 2.0 | 2.0 | — | 4.0 | — | — | 0.2 | 0.2 | 0.05 | 0.05 | — | 0.1 | 33.3 |
| Example 13 | 31.4 | — | — | — | — | 1.6 | — | 0.2 | 1.8 | 0.05 | 0.05 | — | 0.1 | 33.3 |
| Example 14 | 29.2 | — | — | — | — | 3.8 | — | 0.2 | 4.0 | 0.05 | 0.05 | — | 0.1 | 33.3 |
| Example 15 | 28.7 | 2.0 | 0.5 | — | 2.5 | 1.0 | 0.7 | 0.3 | 2.0 | 0.05 | 0.05 | — | 0.1 | 33.3 |
| Example 16 | 27.0 | 6.0 | — | — | 6.0 | — | — | 0.2 | 0.2 | 0.05 | 0.05 | — | 0.1 | 33.3 |
| Example 17 | 26.897 | 6.0 | — | — | 6.0 | — | — | 0.4 | 0.4 | — | — | 0.001 | 0.001 | 33.298 |
| Example 18 | 12.5 | 3.0 | 1.0 | — | 4.0 | — | — | 0.1 | 0.1 | — | — | — | — | 16.6 |
| Example 19 | 77.5 | 17.0 | — | — | 17.0 | 1.0 | — | 0.1 | 1.1 | 0.4 | — | — | 0.4 | 96.0 |
| Example 20 | 30.2 | 1.0 | — | — | 1.0 | 1.0 | 0.7 | 0.3 | 2.0 | 0.05 | 0.05 | — | 0.1 | 33.3 |
| Example 21 | 31.4 | — | — | — | — | 1.6 | — | 0.2 | 1.8 | 0.05 | 0.05 | — | 0.1 | 33.3 |
| Comparative | 33.0 | — | — | — | — | — | — | 0.2 | 0.2 | 0.05 | 0.05 | — | 0.1 | 33.3 |
| example 1 | | | | | | | | | | | | | | |
| Comparative | 27.2 | 6.0 | — | — | 6.0 | — | — | — | — | 0.05 | 0.05 | — | 0.1 | 33.3 |
| example 2 | | | | | | | | | | | | | | |
| Comparative | 26.3 | 6.0 | — | — | 6.0 | — | — | 0.5 | 0.5 | — | — | — | — | 33.3 |
| example 3 | | | | | | | | | | | | | | |
| Comparative | 26.3 | 6.0 | — | — | 6.0 | — | — | — | — | 0.5 | 0.5 | — | 1 | 33.3 |
| example 4 | | | | | | | | | | | | | | |
| Comparative | 24.8 | — | 6.0 | — | 6.0 | 2.3 | — | 0.1 | 2.4 | 0.05 | — | 0.05 | 0.1 | 33.3 |
| example 5 | | | | | | | | | | | | | | |
| Comparative | 91.0 | 5.0 | 1.0 | — | 6.0 | 2.5 | — | 0.3 | 2.8 | 0.1 | 0.1 | — | 0.2 | 100.0 |
| example 6 | | | | | | | | | | | | | | |
| | Monomer composition in monomer mixed solution (II) | | | | | | | | | | | | | |
| | (a1) | | | | | | | | | | | | | |
| | component | (a2) component | | | | (a3) component | | | | (a4) component | | | | |
| | AM | DM | DML | BQ | Total | IA | AA | SMAS | Total | DMAA | MBAA | TAF | Total | Total |
| Example 1 | 64.0 | — | — | — | — | 2.5 | — | 0.1 | 2.6 | 0.05 | 0.05 | — | 0.1 | 66.7 |
| Example 2 | 64.0 | — | — | — | — | 2.5 | — | 0.1 | 2.6 | 0.05 | 0.05 | — | 0.1 | 66.7 |
| Example 3 | 64.0 | — | — | — | — | 2.5 | — | 0.1 | 2.6 | 0.05 | 0.05 | — | 0.1 | 66.7 |
| Example 4 | 64.0 | — | — | — | — | 2.5 | — | 0.1 | 2.6 | 0.05 | 0.05 | — | 0.1 | 66.7 |
| Example 5 | 64.0 | — | — | — | — | 2.5 | — | 0.1 | 2.6 | 0.05 | 0.05 | — | 0.1 | 66.7 |
| Example 6 | 63.5 | — | — | — | — | 2.0 | 1.0 | 0.1 | 3.1 | 0.05 | 0.05 | — | 0.1 | 66.7 |
| Example 7 | 61.5 | — | — | — | — | — | 5.0 | 0.1 | 5.1 | 0.05 | 0.05 | — | 0.1 | 66.7 |
| Example 8 | 64.0 | — | — | — | — | 1.5 | — | 0.3 | 1.8 | 0.05 | 0.05 | — | 0.1 | 66.7 |
| Example 9 | 63.8 | — | — | — | — | 2.5 | — | 0.1 | 2.6 | 0.3 | — | — | 0.3 | 66.7 |
| Example 10 | 64.0 | — | — | — | — | 2.5 | — | 0.1 | 2.6 | 0.05 | — | 0.05 | 0.1 | 66.7 |
| Example 11 | 63.6 | — | — | — | — | 2.5 | — | — | 2.5 | 0.75 | 0.05 | — | 0.8 | 66.7 |
| Example 12 | 64.0 | — | — | — | — | 2.5 | — | 0.1 | 2.6 | 0.05 | 0.05 | — | 0.1 | 66.7 |
| Example 13 | 54.6 | 5.5 | 5.0 | 0.5 | 11.0 | 0.9 | — | 0.1 | 1.0 | 0.05 | 0.05 | — | 0.1 | 66.7 |
| Example 14 | 55.8 | 5.0 | 5.0 | 0.5 | 10.5 | 0.2 | — | 0.1 | 0.3 | 0.05 | 0.05 | — | 0.1 | 66.7 |
| Example 15 | 59.1 | — | — | — | — | — | 7.3 | 0.2 | 7.5 | 0.05 | 0.05 | — | 0.1 | 66.7 |
| Example 16 | 65.5 | — | — | — | — | 1.0 | — | 0.1 | 1.1 | 0.05 | 0.05 | — | 0.1 | 66.7 |
| Example 17 | 65.5 | — | — | — | — | 1.0 | — | 0.2 | 1.2 | — | — | 0.002 | 0.002 | 66.702 |
| Example 18 | 14.5 | 2.0 | — | — | 2.0 | — | — | 0.1 | 0.1 | 0.05 | 0.05 | — | 0.1 | 16.7 |
| Example 19 | — | — | — | — | — | 4.0 | — | — | 4.0 | — | — | — | — | 4.0 |
| Example 20 | 59.1 | — | — | — | — | — | 7.3 | 0.2 | 7.5 | 0.05 | 0.05 | — | 0.1 | 66.7 |
| Example 21 | 57.6 | 4.0 | 4.0 | — | 8.0 | 0.9 | — | 0.1 | 3.1 | 0.05 | 0.05 | — | 0.1 | 66.7 |
| Comparative | 64.0 | — | — | — | — | 2.5 | — | 0.1 | 2.6 | 0.05 | 0.05 | — | 0.1 | 66.7 |
| example 1 | | | | | | | | | | | | | | |
| Comparative | 66.6 | — | — | — | — | — | — | — | — | 0.05 | 0.05 | — | 0.1 | 66.7 |
| example 2 | | | | | | | | | | | | | | |
| Comparative | 64.2 | — | — | — | — | 2.5 | — | 0.5 | 3.0 | — | — | — | — | 66.7 |
| example 3 | | | | | | | | | | | | | | |
| Comparative | 61.7 | — | — | — | — | 2.5 | — | — | 2.5 | 2 | 0.5 | — | 2.5 | 66.7 |
| example 4 | | | | | | | | | | | | | | |
| Comparative | 56.7 | — | — | — | — | 9.7 | — | 0.1 | 9.8 | 0.15 | — | 0.05 | 0.2 | 66.7 |
| example 5 | | | | | | | | | | | | | | |
| Comparative | — | — | — | — | — | — | — | — | — | — | — | — | — | — |
| example 6 | | | | | | | | | | | | | | |

| | Monomer composition in monomer mixed solution (III) | | | | | | | | | |
|---|---|---|---|---|---|---|---|---|---|---|
| | (a1) | | | | | | | | | |
| | component | (a3) component | | | | (a4) component | | | | |
| | AM | IA | AA | SMAS | Total | DMAA | MBAA | TAF | Total | Total |
| Example 1 | | | | | | | | | | |
| Example 2 | | | | | | | | | | |
| Example 3 | | | | | | | | | | |
| Example 4 | | | | | | | | | | |
| Example 5 | | | | | | | | | | |
| Example 6 | | | | | | | | | | |
| Example 7 | | | | | | | | | | |
| Example 8 | | | | | | | | | | |
| Example 9 | | | | | | | | | | |
| Example 10 | | | | | | | | | | |
| Example 11 | | | | | | | | | | |
| Example 12 | | | | | | | | | | |
| Example 13 | | | | | | | | | | |
| Example 14 | | | | | | | | | | |
| Example 15 | | | | | | | | | | |
| Example 16 | | | | | | | | | | |
| Example 17 | | | | | | | | | | |
| Example 18 | 64.0 | 2.5 | — | 0.1 | 2.6 | 0.05 | 0.05 | — | 0.1 | 66.7 |
| Example 19 | | | | | | | | | | |
| Example 20 | | | | | | | | | | |
| Example 21 | | | | | | | | | | |
| Comparative | | | | | | | | | | |
| example 1 | | | | | | | | | | |
| Comparative | | | | | | | | | | |
| example 2 | | | | | | | | | | |
| Comparative | | | | | | | | | | |
| example 3 | | | | | | | | | | |
| Comparative | | | | | | | | | | |
| example 4 | | | | | | | | | | |
| Comparative | | | | | | | | | | |
| example 5 | | | | | | | | | | |
| Comparative | | | | | | | | | | |
| example 6 | | | | | | | | | | |

TABLE 3

| | | Weight- | | |
|---|---|---|---|---|
| | | average | Turbidity | |
| | | molecular | (CaCl₂, 4 mS/cm) | |
| | Viscosity | weight | Maximum value | |
| | (mPa · s) | (Unit: 10K) | (NTU) | Distribution |
| Example 1 | 8500 | 210 | 17 | One peak |
| Example 2 | 8300 | 200 | 350 | One peak |
| Example 3 | 8000 | 190 | 326 | One peak |
| Example 4 | 8600 | 215 | 126 | One peak |
| Example 5 | 8650 | 220 | 52 | One peak |
| Example 6 | 8600 | 220 | 38 | One peak |
| Example 7 | 8500 | 240 | 26 | One peak |
| Example 8 | 8700 | 280 | 40 | One peak |
| Example 9 | 8600 | 300 | 43 | One peak |
| Example 10 | 8800 | 350 | 33 | One peak |
| Example 11 | 12000 | 620 | 46 | One peak |
| Example 12 | 8700 | 280 | 82 | One peak |
| Example 13 | 8300 | 210 | 1200 | One peak |
| Example 14 | 8400 | 160 | 1330 | Two peak |
| Example 15 | 8900 | 250 | 150 | Two peak |
| Example 16 | 8700 | 250 | 80 | One peak |
| Example 17 | 6500 | 150 | 65 | One peak |
| Example 18 | 9000 | 400 | 70 | One peak |
| Example 19 | 2800 | 100 | 2200 | One peak |
| Example 20 | 8700 | 230 | 55 | One peak |
| Example 21 | 8500 | 210 | 780 | One peak |
| Comparative | 8500 | 220 | — | No peak |
| example 1 | | | | |
| Comparative | 8600 | 260 | — | No peak |
| example 2 | | | | |
| Comparative | 1600 | 30 | — | No peak |
| example 3 | | | | |
| Comparative | 15000 | 1000 | 3500 | Two peak |
| example 4 | | | | |
| Comparative | 8600 | 124 | 4200 | Two peak |
| example 5 | | | | |
| Comparative | 8500 | 200 | 3 | One peak |
| example 6 | | | | |

### (Preparation of Paper-Strengthening Agent Solution)

An ion-exchanged water was added to the powdery paper-strengthening agent of each Example and Comparative example so that the solid content concentration became 1.0% to prepare a paper-strengthening agent solution.

(Evaluation on Papermaking 1) Evaluation examples 1 to 21, Comparative evaluation examples 1 to 6

A waste corrugated fiberboard was beaten with a Niagara beater, and calcium chloride was added to a pulp slurry adjusted to have 350 ml of Canadian Standard Freeness (C.S.F) to adjust an electrical conductivity to 4.0 mS/cm. An aluminum sulfate was added to this slurry liquid in a solid content of 1.0% based on a solid content weight of the pulp slurry, and then each of the above-described paper-strengthening agent solutions was added in a solid content of 1.0% based on the solid content weight of the pulp slurry. The pH of each pulp slurry was adjusted to 6.5 for evaluation. After measuring an amount of filtered water of and a yield of the slurry, the slurry was dehydrated with a tappi sheet machine and pressed at 5 kg/cm² for 2 minutes for papermaking with a basis weight of 150 g/m². Next, the paper was dried in a rotary dryer at 105° C. for 4 minutes and subjected to humidity control for 24 hours under a condition of a temperature at 23° C. and a humidity of 50%, and then a specific burst strength, a specific compressive strength, and a retention rate were measured. These results are shown in Table 4. Besides, an electrical conductivity, an amount of filtered water, a yield, a specific burst strength, a specific compressive strength, a coefficient variation of formation, and a retention rate were measured by the following methods.

### <Electrical Conductivity>

An electrical conductivity was measured using pH/COND METER D-54 (manufactured by HORIBA, Ltd.).

### <Freeness>

The freeness was measured according to JIS P 8121 using Canadian Standard Freeness (C.S.F).

### <Yield (OPR)>

A yield was measured using DDJ (Dynamic Drainage Jar). A concentration of a pre-DDJ sample and a concentration of an initial white water extracted by a DDJ operation were determined, which were used to calculate OPR by the following equation.

OPR (%)=(pre-DDJ concentration−concentration of initial white water)÷(pre-DDJ concentration)×100

### <Formation (Coefficient Variation of Formation)>

A value obtained by taking a passing light (brightness) from the paper obtained above into a commercially available measuring instrument (Trade name “Personal image processing system Hyper-700”, manufactured by OBS) and statistically analyzing the brightness distribution was used as a coefficient variation of formation. The results show that the smaller the coefficient variation of formation is, the better the formation is.

### <Specific Burst Strength>

Using the paper obtained above, a specific burst strength (kPa·m²/g) was measured according to JIS P 8131.

### <Specific Compressive Strength>

Using the paper obtained above, a specific compressive strength (N·m²/g) was measured according to JIS P 8126.

### <Retention Rate>

After measuring nitrogen contents of paper 1 and paper 2 using a nitrogen analyzer (manufactured by Mitsubishi Chemical Corporation), a retention rate was calculated from the following equation.

Retention rate (%)=(nitrogen content of paper 1−nitrogen content of paper 2)÷(theoretical nitrogen content of paper-strengthening agent used×addition rate of paper-strengthening agent used)×100

Besides, a theoretical nitrogen content means a mass ratio of nitrogen in a paper-strengthening agent calculated from a molar usage ratio of (a1) to (a5) components of the paper-strengthening agent and a composition formula of each of these components.

TABLE 4

| | | | | Specific | Specific | Coefficient | |
|---|---|---|---|---|---|---|---|
| | | | | burst | compressive | variation of | Retention |
| | | Freeness | OPR | strength | strength | formation | rate |
| | | (mL) | (%) | (kPa · m²/g) | (N · m²/g) | (%) | (%) |
| Evaluation example 1 | Example 1 | 380 | 72.5 | 3.33 | 191 | 22.2 | 62.2 |
| Evaluation example 2 | Example 2 | 390 | 72.8 | 3.31 | 191 | 22.3 | 61.9 |
| Evaluation example 3 | Example 3 | 386 | 72.9 | 3.28 | 190 | 22.1 | 61.3 |
| Evaluation example 4 | Example 4 | 385 | 72.9 | 3.34 | 196 | 22.5 | 63.0 |
| Evaluation example 5 | Example 5 | 386 | 72.8 | 3.38 | 195 | 21.9 | 63.3 |
| Evaluation example 6 | Example 6 | 384 | 73.1 | 3.34 | 193 | 21.8 | 63.5 |
| Evaluation example 7 | Example 7 | 391 | 73.3 | 3.34 | 193 | 21.5 | 64.2 |
| Evaluation example 8 | Example 8 | 386 | 72.0 | 3.33 | 195 | 22.3 | 61.9 |
| Evaluation example 9 | Example 9 | 382 | 73.0 | 3.35 | 196 | 22.0 | 65.3 |
| Evaluation example 10 | Example 10 | 380 | 73.5 | 3.30 | 200 | 23.0 | 66.1 |
| Evaluation example 11 | Example 11 | 395 | 74.0 | 3.22 | 201 | 23.8 | 68.0 |
| Evaluation example 12 | Example 12 | 386 | 72.8 | 3.42 | 195 | 22.2 | 63.0 |
| Evaluation example 13 | Example 13 | 410 | 79.1 | 3.15 | 195 | 24.0 | 69.4 |
| Evaluation example 14 | Example 14 | 430 | 81.2 | 3.11 | 196 | 24.5 | 72.1 |
| Evaluation example 15 | Example 15 | 382 | 73.1 | 3.23 | 192 | 23.5 | 68.1 |
| Evaluation example 16 | Example 16 | 379 | 72.2 | 3.22 | 190 | 22.5 | 62.5 |
| Evaluation example 17 | Example 17 | 375 | 71.8 | 3.22 | 190 | 22.1 | 63.1 |
| Evaluation example 18 | Example 18 | 388 | 73.5 | 3.12 | 185 | 23.0 | 65.3 |
| Evaluation example 19 | Example 19 | 438 | 80.9 | 3.10 | 188 | 23.5 | 68.0 |
| Evaluation example 20 | Example 20 | 375 | 70.2 | 3.02 | 181 | 20.9 | 55.2 |
| Evaluation example 21 | Example 21 | 400 | 77.5 | 3.20 | 194 | 23.5 | 68.0 |
| Comparative evaluation | Comparative | 366 | 68.9 | 2.80 | 174 | 21.0 | 48.7 |
| example 1 | example 1 | | | | | | |
| Comparative evaluation | Comparative | 370 | 69.0 | 2.78 | 176 | 22.0 | 50.3 |
| example 2 | example 2 | | | | | | |
| Comparative evaluation | Comparative | 366 | 68.9 | 2.76 | 171 | 21.2 | 57.7 |
| example 3 | example 3 | | | | | | |
| Comparative evaluation | Comparative | 460 | 80.1 | 2.75 | 189 | 31.4 | 83.0 |
| example 4 | example 4 | | | | | | |
| Comparative evaluation | Comparative | 432 | 81.2 | 2.78 | 190 | 30.3 | 81.6 |
| example 5 | example 5 | | | | | | |
| Comparative evaluation | Comparative | 373 | 68.0 | 2.80 | 175 | 22.1 | 59.1 |
| example 6 | example 6 | | | | | | |

### Evaluation Examples 22 to 24, Comparative Evaluation Examples 7 to 8

Each storage stability of the powdery paper-strengthening agents in Examples 1, 5, 13, and Comparative example 2 was evaluated. Moreover, as Comparative evaluation example 8, the aqueous solution of the (A-1) component obtained by the method of Example 1 was also evaluated in the similar manner.

### <Storage Stability>

The powdery paper-strengthening agent in Example 1 was stored in a thermostat at a temperature of 40° C. for 2 months. Cation values before and after the storage were measured. The cation value was calculated by Equation 1, and a cation decomposition rate was calculated by Equation 2. Besides, the cation value was measured by adjusting pH of a solution, diluted with a deionized water so that a concentration of the paper-strengthening agent became 0.5%, to 2.0 with hydrochloric acid, and then performing colloidal titration with an aqueous solution of potassium polyvinyl sulfate (factor: f=1.00) defined as 1/400 (N) using toluidine blue as an indicator. The cation value was calculated according to Equation 1 with a point, at which a color of a measurement solution changed from blue to reddish violet and the reddish violet was maintained for 10 seconds or longer, being as an end point. Moreover, the powdery paper-strengthening agents in Examples 5, 13, and Comparative example 2, and the aqueous solution of (A-1) the component obtained by the method of Example 1 as a reference comparative example were also measured in the similar manner. The results are shown in Table 5 (the same shall apply hereinafter).

(Cation value)(meq/g)=1/400×f×V/(W×C/100) (Equation 1)

f: factor of aqueous solution of potassium polyvinyl sulfate defined as 1/400 (N)

V: titration value (mL) of aqueous solution of potassium polyvinyl sulfate defined as 1/400 (N)

W: collection quantity (g) of paper-strengthening agents

C: concentration (%) of paper-strengthening agent

(Cation decomposition rate)(%)=[{(cation value before storage)−(cation value after storage)}/(cation value before storage)]×100 (Equation 2)

### (Preparation of Paper-Strengthening Agent Solution)

An ion-exchanged water was added to the above-described powdery paper-strengthening agents in Examples 1, 5, 13, and Comparative example 2 which were stored at 40° C. for 2 hours and the aqueous solution of the (A-1) component so that the solid content concentration became 1.0% to prepare a paper-strengthening agent solution, respectively.

### (Evaluation on Papermaking 2)

A waste corrugated fiberboard was beaten with a Niagara beater, and calcium chloride was added to a pulp slurry adjusted to have 350 ml of Canadian Standard Freeness (C.S.F) to adjust an electrical conductivity to 4.0 mS/cm. An aluminum sulfate was added to this slurry liquid in a solid content of 1.0% based on a solid content weight of the pulp slurry, and then each of the above-described paper-strengthening agent solutions was added in a solid content of 1.0% based on the solid content weight of the pulp slurry. The pH of each pulp slurry was adjusted to 6.5 for evaluation. The slurry was dehydrated with a tappi sheet machine and pressed at 5 kg/cm² for 2 minutes for papermaking with a basis weight of 150 g/m². Next, the paper was dried in a rotary dryer at 105° C. for 4 minutes and subjected to humidity control for 24 hours under a condition of a temperature at 23° C. and a humidity of 50%, and then burst strength was measured in the similar manner as previously to calculate a lowering rate (%) of a specific burst strength by Equation 3. The smaller the numerical value is, the better the lowering rate is. Besides, for a specific burst strength with a paper-strengthening agent solution prepared from a paper-strengthening agent immediately after synthesis, the results in Evaluation on papermaking 1 were used.

Lowering rate of specific burst strength (%)=[{(specific burst strength with a paper-strengthening agent solution prepared from a paper-strengthening agent immediately after synthesis)−(specific burst strength with a paper-strengthening agent solution from a paper-strengthening agent after storage)}/(specific burst strength with a paper-strengthening agent solution prepared from a paper-strengthening agent immediately after synthesis)]×100 (Equation 3)

TABLE 5

| | | | Specific burst strength | | |
|---|---|---|---|---|---|
| | | | (kPa · m²/g) | | |
| | Paper- | Cation | Immediately | 40° C. × | Lowering |
| | strengthening | decomposition | after | storage after | rate |
| | agent | rate (%) | synthesis | 2 months | (%) |
| Evaluation | Example 1 | 2 | 3.33 | 3.29 | 1.2 |
| example 22 | | | | | |
| Evaluation | Example 5 | 2 | 3.38 | 3.34 | 1.1 |
| example 23 | | | | | |
| Evaluation | Example 13 | 3 | 3.15 | 3.10 | 1.5 |
| example 24 | | | | | |
| Comparative | Comparative | 2 | 2.78 | 2.75 | 1.1 |
| evaluation | example 2 | | | | |
| example 7 | | | | | |
| Comparative | Aqueous | 30 | 3.33 | 2.50 | 25.0 |
| evaluation | solution of | | | | |
| example 8 | (A-1) | | | | |
| | component | | | | |

1. A powdery paper-strengthening agent comprising an amphoteric (meth)acrylamide-based polymer having a weight-average molecular weight of 1,000,000 to 7,000,000,
wherein the amphoteric (meth)acrylamide-based polymer comprises, as constituent monomers, (meth)acrylamide which is an component, a cationic unsaturated monomer which is an component, an anionic unsaturated monomer which is an component, and a crosslinkable unsaturated monomer which is an component, and
wherein an aqueous solution, in which the amphoteric (meth)acrylamide-based polymer is dissolved in a calcium chloride aqueous solution having an electrical conductivity of 4 mS/cm at 25° C. so as to be 1% by weight, has a maximum turbidity of 10 to 2500 NTU at pH 3 to 9.

2. The powdery paper-strengthening agent of claim 1,
wherein a content of the component is 70 to 98 mol % in the constituent monomers,
wherein a content of the component is 1.5 to 20 mol % in the constituent monomers,
wherein a content of the component is 0.1 to 10 mol % in the constituent monomers, and
wherein a content of the component is 0.001 to 2 mol % in the constituent monomers.

3. The powdery paper-strengthening agent of claim 1,
wherein the component comprises at least one of an unsaturated monomer having a tertiary amino group and a quaternized salt of the unsaturated monomer having a tertiary amino group.

4. The powdery paper-strengthening agent of claim 1,
wherein the component comprises an unsaturated monomer having a carboxyl group and an unsaturated monomer having a sulfonic group.

5. A paper-strengthening agent solution comprising a powdery paper-strengthening agent of claim 1 and water.

6. Paper obtained by using a paper-strengthening agent solution of claim 5.
